(19) United States
(12) Patent Application Publication
(10) Pub. No.: US 2017/0015904 A1
(43) Pub. Date: Jan. 19, 2017

(54) LIQUID CRYSTAL COMPOSITION AND LIQUID CRYSTAL DISPLAY INCLUDING THE SAME

(71) Applicant: Samsung Display Co., Ltd., Yongin-si (KR)

(72) Inventors: Soon Joon Rho, Suwon-si (KR); Sun Young Kwon, Seoul (KR); Kyung Min Kim, Seoul (KR); Se Ran Kim, Suwon-si (KR); Si Heun Kim, Hwaseong-si (KR); Hoi-Lim Kim, Seoul (KR); Beom-Soo Shin, Hwaseong-si (KR); Keun Chan Oh, Cheonan-si (KR); Hye Kim Jang, Hwaseong-si (KR)

(21) Appl. No.: 15/003,421

(22) Filed: Jan. 21, 2016

(30) Foreign Application Priority Data
Jul. 13, 2015 (KR) 10-2015-0098957

(51) Int. Cl. C09K 19/30; G02F 1/1337

(52) U.S. Cl. CPC C09K 19/3066; G02F 1/133711; G02F 2001/133746

(57) ABSTRACT

A liquid crystal composition includes a first compound represented by Chemical Formula 1.

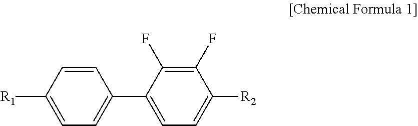

In Chemical Formula 1, R₁ is an alkyl group having a carbon number of 1 to 10 or a cycloalkyl group having a total carbon number of 3 to 16, and R₂ is an alkoxy group having a carbon number of 1 to 10. The liquid crystal composition does not include a compound having an alkenyl as a substituent group, and the liquid crystal composition does not include a compound represented by Chemical Formula 4.

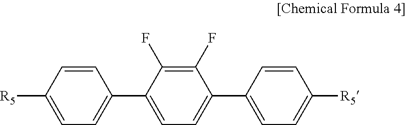

In Chemical Formula 4, R₅ and R₅′ are independently an alkyl group having a carbon number of 1 to 10 or an alkoxy group having a carbon number of 1 to 10.

This application claims priority to and the benefit of Korean Patent Application No. 10-2015-0098957, filed on Jul. 13, 2015, and all the benefits accruing therefrom under 35 U.S.C. §119, the contents of which in their entirety are herein incorporated by reference.

### BACKGROUND

(a) Field

The present invention relates to a liquid crystal composition and a liquid crystal display including the same.

(b) Description of the Related Art

Liquid crystal displays are widely used as one type of flat panel display. The liquid crystal display includes two display panels on which field generating electrodes are formed, and a liquid crystal layer interposed between the display panels. In the liquid crystal display, a voltage is applied to the field generating electrodes to generate an electric field across the liquid crystal layer, and the alignment of liquid crystal molecules in the liquid crystal layer is determined by the electric field. Accordingly, the polarization of incident light can be controlled, thereby performing image display.

The liquid crystal display includes a liquid crystal material that is capable of controlling the transmittance of light and obtaining the desired images. Particularly, according to the various uses of the liquid crystal display, characteristics such as a low voltage driving, a high voltage holding ratio (VHR), a wide viewing angle characteristic, a wide range of operation temperature, and high speed response are desired.

The above information disclosed in this Background section is only for enhancement of understanding of the background of the invention and therefore it may contain information that does not form the prior art that is already known in this country to a person of ordinary skill in the art.

### SUMMARY

The present invention provides a liquid crystal composition having excellent alignment control force of the liquid crystal molecules and an improved degree of an afterimage, and a liquid crystal display including the same.

An exemplary embodiment provides a liquid crystal composition including a first compound represented by Chemical Formula 1.

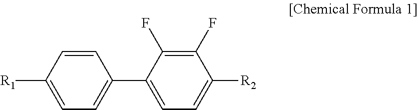

In Chemical Formula 1 R₁ is an alkyl group having a carbon number of 1 to 10 or a cycloalkyl group having a total carbon number of 3 to 16, and R₂ is an alkoxy group having a carbon number of 1 to 10. The liquid crystal composition does not include a compound having an alkenyl as a substituent group, and the liquid crystal composition does not include a compound represented by Chemical Formula 4.

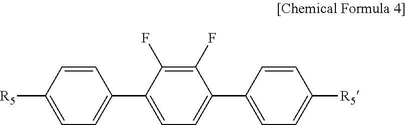

In Chemical Formula 4, R₅ and R₅′ are independently an alkyl group having a carbon number of 1 to 10 or an alkoxy group having a carbon number of 1 to 10.

In an exemplary embodiment, the liquid crystal composition may further include a second compound represented by Chemical Formula 2.

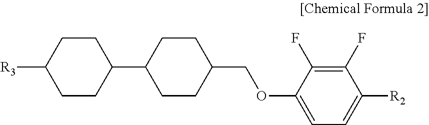

In Chemical Formula 2, R₂ is an alkoxy group having a carbon number of 1 to 10, and R₃ is an alkyl group having a carbon number of 1 to 8.

In an exemplary embodiment, the first compound is present in an amount of about 20 weight percent (wt %) to about 40 wt % with respect to a total weight of the liquid crystal composition.

In an exemplary embodiment, the first compound may be a compound represented by Chemical Formula 1.1.

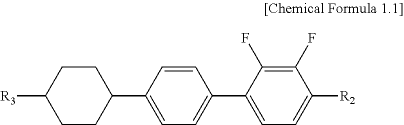

In Chemical Formula 1.1, R₂ is an alkoxy group having a carbon number of 1 to 10, and R₃ is an alkyl group having a carbon number of 1 to 8.

In an exemplary embodiment, the liquid crystal composition may further include a compound represented by Chemical Formula 6 to Chemical Formula 8.

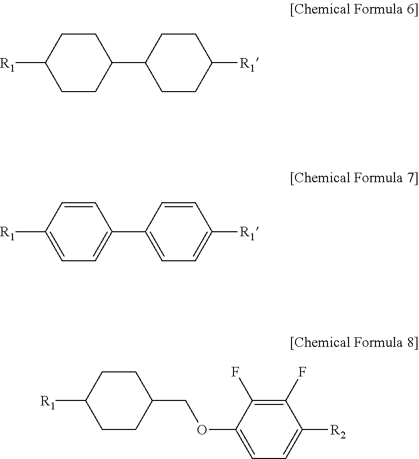

In Chemical Formula 6 to Chemical Formula 8, R₁ and R₁′ are independently an alkyl group having a carbon number of 1 to 10 or a cycloalkyl group having a total carbon number of 3 to 16, and R₂ is an alkoxy group having a carbon number of 1 to 10.

Another exemplary embodiment provides a liquid crystal display including a first substrate, a second substrate facing the first substrate, a field generating electrode disposed on at least one of the first substrate and the second substrate, and a liquid crystal layer disposed of a liquid crystal composition interposed between the first substrate and the second substrate, wherein the liquid crystal composition includes a first compound represented by Chemical Formula 1.

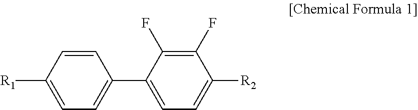

In Chemical Formula 1, R₁ is an alkyl group having a carbon number of 1 to 10 or a cycloalkyl group having a total carbon number of 3 to 16, and R₂ is an alkoxy group having a carbon number of 1 to 10. The liquid crystal composition does not include a compound having an alkenyl as a substituent group, and the liquid crystal composition does not include a compound represented by Chemical Formula 4.

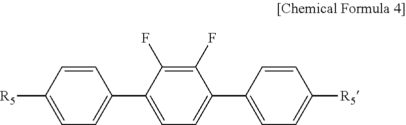

In Chemical Formula 4, R₅ and R₅′ are independently an alkyl group having a carbon number of 1 to 10 or an alkoxy group having a carbon number of 1 to 10.

In an exemplary embodiment, an alignment layer positioned on the field generating electrode may be further included, and the alignment layer may include an alignment aid represented by Chemical Formula 5.

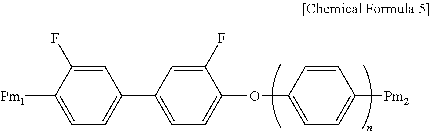

In Chemical Formula 5, Pm₁ and Pm₂ are each a (meth)acrylate group, and n is 1 to 2.

In an exemplary embodiment, the liquid crystal composition may include a plurality of liquid crystal molecules, and the liquid crystal molecules may be pretilted with respect to the first substrate or the second substrate.

In another exemplary embodiment, the pretilt of the liquid crystal molecules may be about 86 degrees to about 87.5 degrees.

The exemplary liquid crystal composition and the liquid crystal display including the same may have excellent liquid crystal alignment control force and may improve the afterimage that may be generated in the display device.

### BRIEF DESCRIPTION OF THE DRAWINGS

The above and other aspects, advantages and features of this disclosure will become more apparent by describing in further detail exemplary embodiments thereof with reference to the accompanying drawings, in which:

FIG. 1 is an equivalent circuit diagram of a pixel of an exemplary embodiment of a liquid crystal display.

FIG. 2 is a plan view of an exemplary embodiment of a liquid crystal display.

FIG. 3 is a cross-sectional view taken along line of FIG. 2.

### DETAILED DESCRIPTION

The present invention will now be described more fully hereinafter with reference to the accompanying drawings, in which various embodiments of the invention are shown. The described embodiments may be modified in various different ways, all without departing from the spirit or scope of the present invention, and should not be construed as limited to the embodiments set forth herein. Rather, these embodiments are provided so that this disclosure will be thorough and complete, and will fully convey the scope of the invention to those skilled in the art.

In the drawings, the thickness of layers, films, panels, regions, etc., are exaggerated for clarity. Like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. For example, if the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, if the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims.

Hereafter, an exemplary embodiment of a liquid crystal composition will be described in detail.

In an exemplary embodiment, the liquid crystal composition includes a first compound represented by Chemical Formula 1.

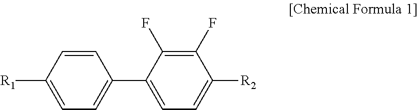

In Chemical Formula 1, R₁ is an alkyl group having a carbon number of 1 to 10 or a cycloalkyl group having a total carbon number of 3 to 16, and R₂ is an alkoxy group having a carbon number of 1 to 10.

The first compound may be included in the liquid crystal composition in an amount of about 20 wt % to about 40 wt % with respect to the total weight of the liquid crystal composition. When the first compound is present within this range, a pretilt angle of the liquid crystal molecules is excellently implemented, and it is possible to improve the liquid crystal alignment control force.

The first compound may be a compound represented by Chemical Formula 1.1.

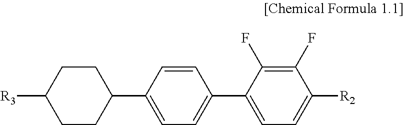

In Chemical Formula 1.1, R₂ is an alkoxy group having a carbon number of 1 to 10, and R₃ is an alkyl group having a carbon number of 1 to 8.

In an exemplary embodiment, the liquid crystal composition may further include a second compound represented by Chemical Formula 2.

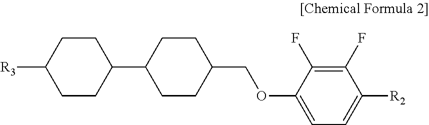

In Chemical Formula 2, R₂ is an alkoxy group having a carbon number of 1-10, and R₃ is an alkyl group having a carbon number of 1-8.

The liquid crystal composition including the first compound and the second compound may have high polarity and low viscosity.

However, in an exemplary embodiment, the liquid crystal composition does not include a third compound that is a liquid crystal molecule including an alkenyl group as a substituent.

For example, the third compound including an alkenyl group may be a compound represented by Chemical Formula 3.1 to Chemical Formula 3.2.

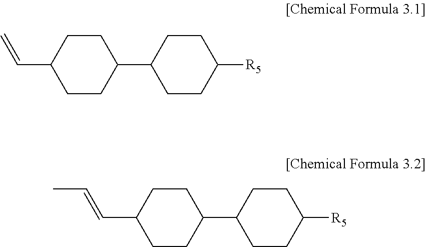

In Chemical Formula 3.1 and Chemical Formula 3.2, R₅ is an alkyl group having a carbon number of 1 to 10 or an alkoxy group having a carbon number of 1 to 10. Thus in one embodiment, the liquid crystal composition does not include a compound represented by Chemical Formulas 3.1 to 3.

The liquid crystal composition also does not include a fourth compound represented by Chemical Formula 4.

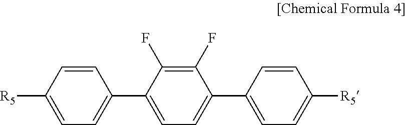

In Chemical Formula 4, R₅ and R₅′ are independently an alkyl group having a carbon number of 1 to 10 or an alkoxy group having a carbon number of 1 to 10.

The exemplary liquid crystal composition has been adapted to a liquid crystal display in which a reactive mesogen is included in the alignment layer in order for the liquid crystal molecules to have the pretilt angle. When the third compound and the fourth compound are included in the liquid crystal composition, the voltage holding ratio may be deteriorated, and as a result, an afterimage may be generated. Accordingly, the exemplary liquid crystal composition includes the first compound and the second compound and excludes the third compound and the fourth compound, so that the deterioration of the voltage holding ratio of the voltage may be prevented and the afterimage may be improved.

That is, the exemplary liquid crystal composition uses the first compound and the second compound instead of the third compound and the fourth compound, thereby improving the afterimage that may be generated when driving the liquid crystal display.

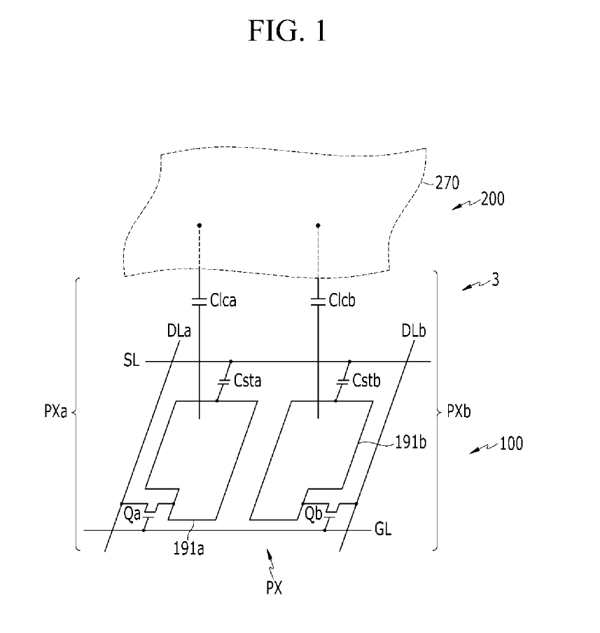

Next, an exemplary embodiment of the liquid crystal display will be described with reference to FIG. 1 to FIG. 3.

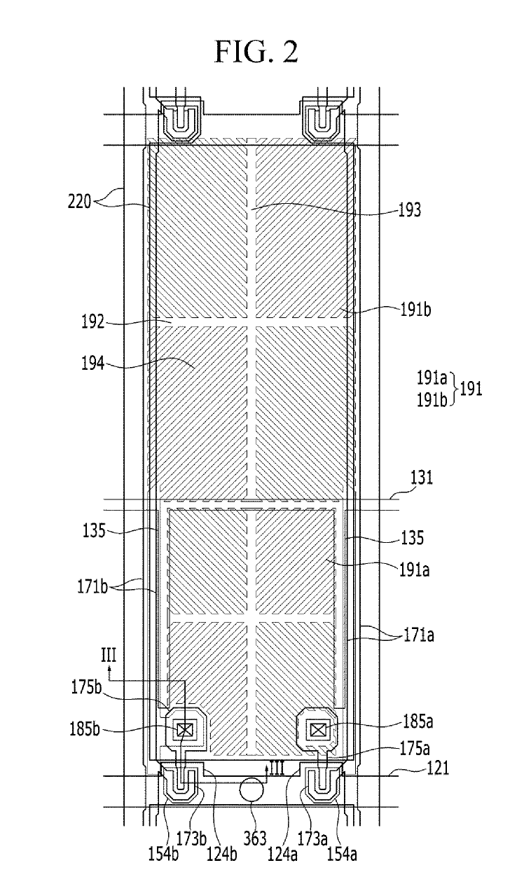

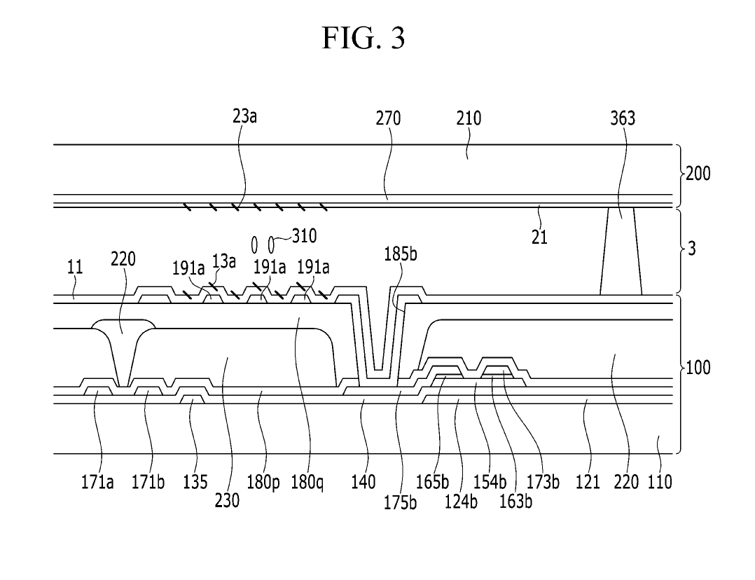

FIG. 1 is an equivalent circuit diagram of a pixel of an exemplary embodiment of a liquid crystal display, FIG. 2 is a plan view of an exemplary embodiment of a liquid crystal display, and FIG. 3 is a cross-sectional view taken along line of the liquid crystal display in FIG. 2.

Referring to FIG. 1, the exemplary liquid crystal display includes a thin film transistor array (lower) panel 100 and a common electrode (upper) panel 200 facing each other, and a liquid crystal layer 3 interposed therebetween.

The liquid crystal display includes signal lines including a plurality of gate lines GL, a plurality of pairs of data lines DLa and DLb, and a plurality of storage electrode lines SL, and a plurality of pixels PX connected thereto.

The respective pixels PX include a pair of sub-pixels PXa and PXb, and each sub-pixel PXa/PXb includes a switching element Qa/Qb, a liquid crystal capacitor Clca/Clcb, and a storage capacitor Csta/Cstb.

The switching elements Qa and Qb are three-terminal elements such as thin film transistors formed on the lower panel 100. The control terminals of the switching elements Qa and Qb are connected to the gate lines GL, the input terminals thereof are connected to the data lines DLa and DLb, and the output terminals thereof are connected to the liquid crystal capacitors Clca and Clcb and the storage capacitors Csta and Cstb.

The liquid crystal capacitors Clca and Clcb have sub-pixel electrodes 191a and 191b and a common electrode 270 serving as two terminals, and the liquid crystal layer 3 interposed between the two terminals as a dielectric.

The storage capacitors Csta and Cstb serving to assist the liquid crystal capacitors Clca and Clcb, are formed through overlapping the storage electrode line SL with the sub-pixel electrodes 191a and 191b by interposing an insulator, and applying a predetermined voltage such as a common voltage (Vcom) to the storage electrode line SL.

The voltages charged at the two liquid crystal capacitors Clca and Clcb are established to slightly differ from each other. For example, the data voltage applied to one of the liquid crystal capacitors Clca is established to be always lower or higher than the data voltage applied to the other liquid crystal capacitor Clcb. When the voltages of the two liquid crystal capacitors Clca and Clcb are properly controlled, an image viewed from the lateral side of the liquid crystal display maximally approximates an image viewed from the frontal side, thereby improving the lateral visibility of the liquid crystal display.

Now, an exemplary embodiment of the liquid crystal display will be described in detail with reference to FIG. 2 and FIG. 3.

Referring to FIG. 2 and FIG. 3, an exemplary embodiment of a liquid crystal display includes lower and upper display panels 100 and 200 facing each other, and the liquid crystal layer 3 interposed between the two panels 100 and 200.

The lower panel 100 will be described first in detail.

A plurality of gate lines 121 and a plurality of storage electrode lines 131 and 135 are formed on an insulation substrate 110.

The gate lines 121 transmit gate signals and are substantially extended in the transverse direction. Each gate line 121 includes a plurality of first and second gate electrodes 124a and 124b protruding upward.

The storage electrode lines 135 include a stem 131 extending substantially parallel to the gate lines 121 and a plurality of storage electrodes 135 extended from the stem 131. However, the shapes and arrangements of the storage electrode lines 131 and 135 may be modified in various forms.

The gate lines 121 and the storage electrode lines 131 and 135 may be formed of at least one metal selected from the group consisting of an aluminum-based metal such as aluminum (Al) and an aluminum alloy, a silver-based metal such as silver (Ag) and a silver alloy, and a copper-based metal such as copper (Cu) and a copper alloy.

The present exemplary embodiment describes that the gate lines 121 and the gate electrodes 124a and 124b are formed of a single layer, but they are not limited thereto, and the gate lines 121 and the gate electrodes 124a and 124b may be formed in a dual layer or triple layer form.

In the case where the gate lines and the gate electrodes have a dual-layer structure, the gate lines 121 and the gate electrodes 124a and 124b may be formed of a lower layer and an upper layer, and the lower layer may be formed of at least one metal selected from the group consisting of a molybdenum-based metal such as molybdenum (Mo) and a molybdenum alloy, chromium (Cr), a chromium alloy, titanium (Ti), a titanium alloy, tantalum (Ta), a tantalum alloy, manganese (Mn), and a manganese alloy. The upper layer may be formed of at least one metal selected from the group consisting of an aluminum-based metal such as aluminum (Al) and an aluminum alloy, a silver-based metal such as silver (Ag) and a silver alloy, and a copper-based metal such as copper (Cu) and a copper alloy. In the case of the triple layer structure, the gate lines and the gate electrodes may be formed by a combination of layers having different physical properties.

A gate insulating layer 140 is formed on the gate lines 121 and the storage electrode lines 131 and 135, and a plurality of semiconductors 154a and 154b are formed on the gate insulating layer 140. The semiconductors 154a and 154b may be made of amorphous or crystalline silicon and the like

A plurality pairs of ohmic contacts 163b and 165b are formed on the semiconductors 154a and 154b. The ohmic contacts 163b and 165b may be made of a material such as n+ hydrogenated amorphous silicon in which a silicide or an n-type impurity is doped at a high concentration.

A plurality of pairs of data lines 171a and 171b and a plurality pairs of first and second drain electrodes 175a and 175b are formed on the ohmic contacts 163b and 165b and the gate insulating layer 140.

The data lines 171a and 171b transfer a data signal and mainly extend in a vertical direction to cross the stem lines 131 of the storage electrode lines and the gate line 121. The data lines 171a and 171b extend toward the first and second gate electrodes 124a and 124b and include first and second source electrodes 173a and 173b bent in a U-shape. The first and second source electrodes 173a and 173b face first and second drain electrodes 175a and 175b with the first and second gate electrodes 124a and 124b interposed therebetween.

The data lines 171a and 171b may be formed of at least one metal selected from the group consisting of an aluminum-based metal such as aluminum (Al) and an aluminum alloy, a silver-based metal such as silver (Ag) and a silver alloy, and a copper-based metal such as copper (Cu) and a copper alloy. The present exemplary embodiment describes that the data lines 171a and 171b are formed of a single layer, but they are not limited thereto, and the data lines 171a and 171b may also be formed in a dual layer or triple layer form.

Each of the first and second drain electrodes 175a and 175b extends upward from an end thereof, which is partially surrounded by the first and second source electrodes 173a and 173b, and the other end thereof may have a wide area for connection to another layer.

However, the shape and disposal of the first and second drain electrodes 175a and 175b and the data lines 171a and 171b may be variously changed.

The first and second gate electrodes 124a and 124b, the first and second source electrodes 173a and 173b, and the first and second drain electrodes 175a and 175b, together with the first and second semiconductors 154a and 154b, form first and second thin film transistors Qa and Qb. Channels of the first and second thin film transistors Qa and Qb are formed in the first and second semiconductors 154a and 154b between the first and second source electrodes 173a and 173b and the first and second drain electrodes 175a and 175b.

The ohmic contacts 163b and 165b exist only between the semiconductors 154a and 154b therebeneath and the data lines 171a and 171b and the drain electrodes 175a and 175b thereon, and reduce contact resistance therebetween. In the semiconductors 154a and 154b, an exposed portion that is not covered with the data lines 171a and 171b and the drain electrodes 175a and 175b exists between the source electrodes 173a and 173b and the drain electrodes 175a and 175b.

A lower passivation layer 180p made of a silicon nitride or a silicon oxide is formed on the data lines 171a and 171b, the drain electrodes 175a and 175b, and the exposed portions of the semiconductors 154a and 154b.

A color filter 230 is formed on the lower passivation layer 180p. The color filter 230 may include a color filter having the colors of red, green, and blue. A light blocking member 220 is formed on the color filter 230. The light blocking member 220 may be a single layer or a dual layer of chromium and a chromium oxide, or an organic material, and may have openings arranged in a matrix form.

An upper passivation layer 180q formed of a transparent organic insulating material is formed on the color filter 230 and the light blocking member 220. The upper passivation layer 180q prevents the color filter 230 from being exposed and provides a flat surface. A plurality of contact holes 185a and 185b through which the first and second drain electrodes 175a and 175b are exposed, are formed in the passivation layer 180q.

A plurality of pixel electrodes 191 are formed on the upper passivation layer 180q. The pixel electrodes 191 may be made of a transparent conductive material such as indium tin oxide (ITO) or indium zinc oxide (IZO), or a reflective metal such as aluminum, silver, chromium, or an alloy thereof.

Each pixel electrode 191 includes the first and second subpixel electrodes 191a and 191b separated from each other. The first and second subpixel electrodes 191a and 191b each include a cross-type stem portion formed of a horizontal stem portion 192 and a vertical stem portion 193 crossing the horizontal stem portion, and fine branch portions 194 extending in an incline direction from the horizontal stem portion 192 and the vertical stem portion 193.

A first alignment layer 11 is formed on an inner surface of the lower panel 100, and the first alignment layer 11 may be a vertical alignment layer. The first alignment layer 11 may be formed to include at least one material generally used as an alignment layer for the liquid crystals, such as polyamic acid, polyimide, or the like. The first alignment layer 11 includes an alignment polymer 13a formed by irradiating light onto an alignment aid. The alignment aid may be a reactive mesogen.

In the exemplary embodiment, the alignment aid includes a fifth compound represented by Chemical Formula 5.

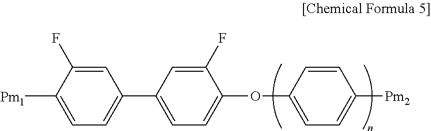

In Chemical Formula 5, Pm₁ and Pm₂ are respectively a (meth)acrylate group, and n is 1 to 2.

Next, the upper panel 200 will be described.

The common electrode 270 is formed on an entire surface of a transparent insulating substrate 210 in the upper panel 200.

A second alignment layer 21 is formed on an inner surface of the upper panel 200, and the second alignment layer 21 may be a vertical alignment layer. The second alignment layer 21 may be formed to include at least material generally used as an alignment layer for the liquid crystals, such as polyamic acid, polyimide, or the like. The second alignment layer 21 includes the alignment polymer 23a formed by irradiating light onto an alignment aid. The alignment aid may be a reactive mesogen.

In an exemplary embodiment, the alignment aid includes the fifth compound represented by Chemical Formula 5.

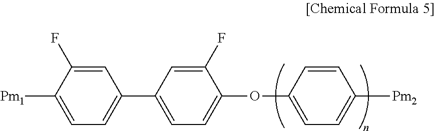

In Chemical Formula 5, Pm₁ and Pm₂ are each a (meth)acrylate group, and n is 1 to 2.

In general, the alignment aid used to form the alignment polymer uses a reactive mesogen compound made of two ring compounds. Compared to this, in an exemplary embodiment, the first and second alignment layers 11 and 21 use the fifth compound of which the entire length of the reactive mesogen compound is relatively long. Due to the length, the reactive mesogen may be prevented from being hardened during a baking process which is included as one among several process steps used to form the first and second alignment layers 11 and 21.

Spacers 363 are formed so as to space the upper and lower panels 200 and 100 apart from each other by a predetermined distance.

A polarizer (not shown) may be provided on external surfaces of the lower display panel 100 and the upper display panel 200.

The liquid crystal layer 3 is interposed between the lower panel 100 and the upper panel 200. The liquid crystal layer 3 includes a plurality of liquid crystal molecules 310.

The liquid crystal molecules 310 have negative dielectric anisotropy, and are aligned so that long axes thereof are almost perpendicular to surfaces of the two panels 100 and 200 in a state where there is no electric field applied to the liquid crystal layer.

In the present exemplary embodiment, the liquid crystal layer 3 includes the liquid crystal molecules 310 formed of the exemplary aforementioned liquid crystal composition. In detail, in an exemplary embodiment, the liquid crystal layer 3 includes a liquid crystal composition including the first compound represented by Chemical Formula 1.

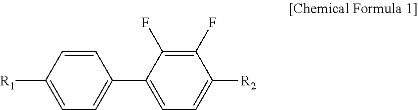

In Chemical Formula 1, R₁ is an alkyl group having a carbon number of 1 to 10 or a cycloalkyl group having a total carbon number of 3 to 16 (in which the ring may have a carbon number of 3 to 8, and is optionally substituted with an alkyl group having a carbon number of 1 to 8, and R₂ is an alkoxy group having a carbon number of 1 to 10.

The first compound may be the compound represented by Chemical Formula 1.1.

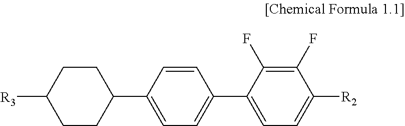

In Chemical Formula 1.1, R₂ is an alkoxy group having a carbon number of 1 to 10, and R₃ is an alkyl group having a carbon number of 1 to 8.

In an exemplary embodiment, the liquid crystal composition may further include a second compound represented by Chemical Formula 2.

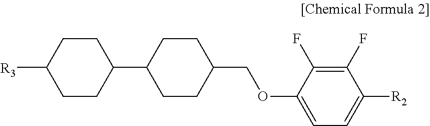

In Chemical Formula 2, R₂ is an alkoxy group having a carbon number of 1 to 10, and R₃ is an alkyl group having a carbon number of 1 to 8.

In an exemplary embodiment, the liquid crystal composition does not include a third compound including an alkenyl as a substituent group.

For example, the third compound including an alkenyl may be a compound represented by Chemical Formula 3.1 to Chemical Formula 3.2, however it is limited thereto.

Thus in one embodiment, the liquid crystal composition does not include a compound represented by Chemical Formulas 3.1 to 3.2.

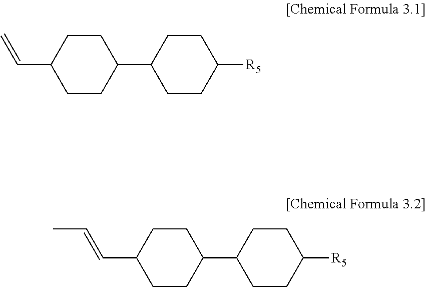

In Chemical Formula 3.1 and Chemical Formula 3.2, R₅ is an alkyl group having a carbon number of 1 to 10 or an alkoxy group having a carbon number of 1 to 10.

The liquid crystal composition also does not include a fourth compound represented by Chemical Formula 4.

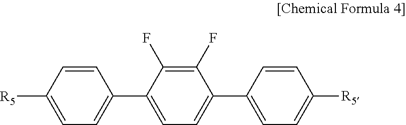

In Chemical Formula 4, R₅ and R₅′ are independently an alkyl group having a carbon number of 1 to 10 or an alkoxy group having a carbon number of 1 to 10.

When a voltage is applied to the pixel electrode 191 and the common electrode 270, the liquid crystal molecules 310 respond to the electric field formed between the pixel electrode 191 and the common electrode 270 so that the direction of the long axes of the liquid crystal molecules 310 are changed to a direction perpendicular to the direction of the electric field. The polarization of incident light is changed in the liquid crystal layer 3 according to the degree in inclination of the liquid crystal molecules 310. The change in the polarization is shown as a change in transmittance by the polarizer, and the liquid crystal display displays an image through the change in the transmittance.

The inclined direction of the liquid crystal molecule 310 is determined by the minute branch portions 194 of the pixel electrode 191, and in particular, the liquid crystal molecule 310 is inclined in a direction parallel to the longitudinal direction of the fine branch portions 194. Since one pixel electrode 191 includes four subregions where length directions of the fine branch portions 194 are different from each other, the liquid crystal molecules 310 are inclined in approximately four different directions, and thus four domains in which the alignment direction of the liquid crystal molecules 310 are different from each other are formed in the liquid crystal layer 3. As described above, a viewing angle of the liquid crystal display may therefore be improved by diversifying the inclination direction of the liquid crystal molecules.

In an exemplary embodiment, the liquid crystal display may largely improve the degree to which the afterimage is generated by controlling the pre-tilt (i.e. an initial alignment direction) of the liquid crystal molecules 310 using the alignment polymer (13a and 23a) formed by the polymerization of the alignment aid, and by using the exemplary liquid crystal composition designed to have excellent alignment control force.

Hereinafter, the characteristics of exemplary liquid crystal compositions will now be described in detail.

First, to describe the characteristics of an exemplary liquid crystal composition, a liquid crystal composition A as an experimental example of the liquid crystal composition and a liquid crystal composition B as a comparative example, are manufactured with the materials shown in Table 1.

As shown in Table 1, the liquid crystal composition A (Experimental Example 1) excludes the third compound and the fourth compound while including the first compound and the second compound. In comparison, the liquid crystal composition B (Comparative Example) excludes the first compound while including the third compound and the fourth compound. In the chemical formulae of Table 1 and Table 2 to be described, R₁ and R₁′ are independently an alkyl group having a carbon number of 1 to 10 or a cycloalkyl group having a total carbon number of 3 to 16, R₂ is an alkoxy group having a carbon number of 1 to 10, R₃ is an alkyl group having a carbon number of 1 to 8, and R₅ and R₅′ are independently an alkyl group having a carbon number of 1 to 10 or an alkoxy group having a carbon number of 1 to 10.

TABLE 1

| | Liquid crystal | Liquid crystal composition |
|---|---|---|
| | composition A | B |
| | (Experimental | (Comparative Example 1) |
| | Example 1)(wt %*) | (wt %*) |
| [third compound] | | |
| 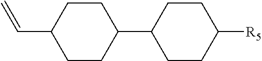 | — | 26.5% |
| [third compound] | | |
| 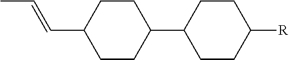 | — | 10% |
| 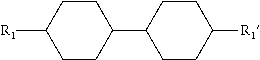 | 27% | — |
| 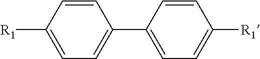 | 12% | 3% |
| 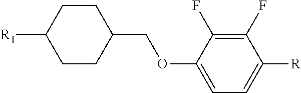 | 14.5% | 16% |
| [first compound] | | |
| 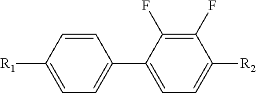 | 21.5% | — |
| [second compound] | | |
| 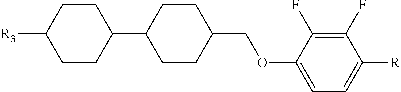 | 19% | 19% |
| 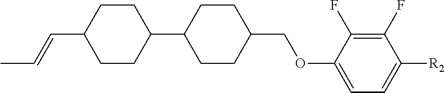 | — | 7% |
| [fourth compound] | | |
| 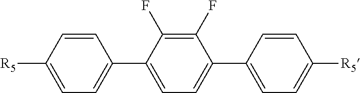 | — | 17% |

*Amounts are based on the total weight of the liquid crystal composition.

Next, the manufactured liquid crystal composition A and liquid crystal composition B are respectively inserted within liquid crystal displays formed to include the alignment layer including the fifth compound represented by Chemical Formula 5. Then the liquid crystal display is driven to perform the experiment to determine the generation of the afterimage. Specifically, the fifth compound has a structure represented by Formula 5 below.

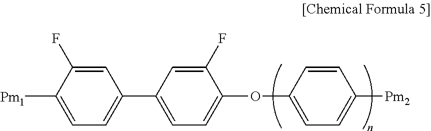

In Chemical Formula 5, Pm₁ and Pm₂ are the (meth)acrylate group (i.e., either acrylate or methacrylate), and n is 1 to 2.

Two additional comparative examples are prepared based on the liquid crystal composition B (Comparative Example 1). While the rest of the components in liquid crystal composition B are maintained as is, the amounts of the third compound and the fourth compound are changed as shown in Table 2 below, to additionally manufacture Comparative Examples 2 and 3.

TABLE 2

| | [third compound] | [fourth compound] |
|---|---|---|
| Liquid crystal composition B | 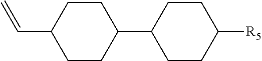 | 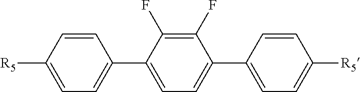 |
| Comparative Example | 20% | 10% |
| 2 | | |
| Comparative Example | 19% | 2% |
| 3 | | |

The generation degree of the afterimage according thereto will be described with reference to Table 3.

Table 3 shows afterimage generation existence.

TABLE 3
Afterimage generation existence

| | |
|---|---|
| Liquid crystal composition A | Liquid crystal composition B |

| | | | |
|---|---|---|---|
| Experimental | Hardly | Comparative | Afterimage |
| Example 1 | generated | Example 1 | generation |
| | | Comparative | Afterimage |
| | | Example 2 | generation |
| | | Comparative | Afterimage |
| | | Example 3 | generation |

Referring to Table 3, in the case of the liquid crystal composition in which the first compound is included and the third compound and the fourth compound are not included (Experimental Example 1), the afterimage is hardly generated, however in the case of the liquid crystal composition B in which the first compound is not included and the third compound and the fourth compound are included (Comparative Examples 1-3), the afterimage is generated.

Next, when using the liquid crystal composition and the exemplary alignment layer, to assess the generation degree of the pretilt of the liquid crystal molecules in the liquid crystal display including the Experimental Example and the Comparative Example 1 of Table 1 shown above, the pretilt of the liquid crystal molecule is measured. The results are shown in Table 4 below.

TABLE 4

| | Liquid crystal composition | Liquid crystal composition |
|---|---|---|
| | A (Experimental Example) | B (Comparative Example 1) |
| Pretilt angle (°) | 86.4 | 89.2 |

As shown in Table 4, in the case of the Experimental Example, the pretilt of the liquid crystal molecules is sufficiently generated. However, the pretilt of the liquid crystal molecules is not sufficiently generated in the case of the Comparative Example 1.

Also, when the exemplary liquid crystal composition and the alignment layer are used, to assess the generation degree of the pretilt depending on the content of the first compound in the liquid crystal composition, the content of the first compound in the liquid crystal composition A of Table 1 above is changed and the pretilt of the liquid crystal molecule is measured. The result thereof is shown in Table 5.

TABLE 5

| | First compound 21.5 wt % | First compound 40 wt % |
|---|---|---|
| Pretilt angle (°) | 86.7 | 87.2 |

As shown in Table 5, when the content of the first compound is 40 wt %, the pretilt angle is somehow decreased as compared with the content of 21.5 wt %. Thus it may be confirmed that it is difficult to sufficiently generate the desired pretilt when the amount of the first compound is too small or large.

Through the above experimental results, the exemplary liquid crystal display combines the liquid crystal composition including the first compound and the second compound and the alignment layer including the fifth compound to obtain excellent liquid crystal alignment control force, thereby sufficiently generating the pretilt and improving the afterimage.

As described above, in the liquid crystal composition and the liquid crystal display according to an exemplary embodiment of the present invention, the liquid crystal alignment control force is excellent and the degree of the afterimage that may be generated in the display device may be improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A liquid crystal composition comprising,
a first compound represented by Chemical Formula 1: 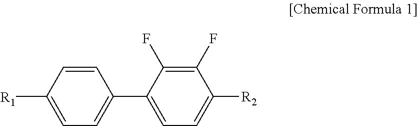
wherein, in Chemical Formula 1 R₁ is an alkyl group having a carbon number of 1 to 10 or a cycloalkyl group having a total carbon number of 3 to 16, and R₂ is an alkoxy group having a carbon number of 1 to 10, and
the liquid crystal composition does not include a compound having an alkenyl as a substituent group, and
the liquid crystal composition does not include a compound represented by Chemical Formula 4: 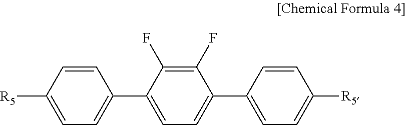
wherein, in Chemical Formula 4, R₅ and R₅′ are independently an alkyl group having a carbon number of 1 to 10 or an alkoxy group having a carbon number of 1 to 10.

2. The liquid crystal composition of claim 1, further including
a second compound represented by Chemical Formula 2: 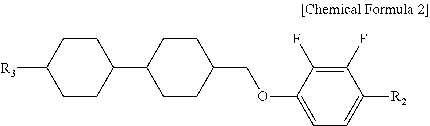
wherein, in Chemical Formula 2, R₂ is an alkoxy group having a carbon number of 1 to 10, and R₃ is an alkyl group having a carbon number of 1 to 8.

3. The liquid crystal composition of claim 2, wherein
the first compound is present in an amount of about 20 wt % to about 40 wt % with respect to a total weight of the liquid crystal composition.

4. The liquid crystal composition of claim 2, wherein
the first compound is a compound represented by Chemical Formula 1.1: 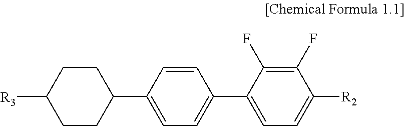
wherein, in Chemical Formula 1.1, R₂ is an alkoxy group having a carbon number of 1 to 10, and R₃ is an alkyl group having a carbon number of 1 to 8.

5. The liquid crystal composition of claim 3, further comprising
a compound represented by Chemical Formula 6 to Chemical Formula 8: 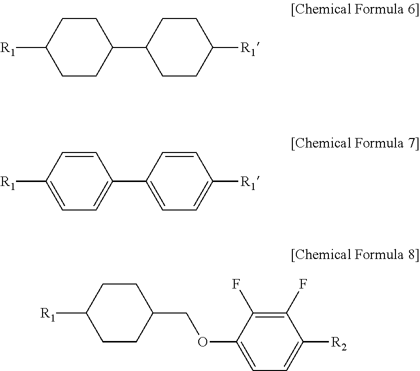
wherein, in Chemical Formula 6 to Chemical Formula 8, R₁ and R₁′ are independently an alkyl group having a carbon number of 1 to 10 or a cycloalkyl group having a total carbon number of 3 to 16, and R₂ is an alkoxy group having a carbon number of 1 to 10.

6. A liquid crystal display comprising
a first substrate,
a second substrate facing the first substrate,
a field generating electrode disposed on at least one of the first substrate and the second substrate, and
a liquid crystal layer comprising a liquid crystal composition interposed between the first substrate and the second substrate,
wherein the liquid crystal composition comprises a first compound represented by Chemical Formula 1: 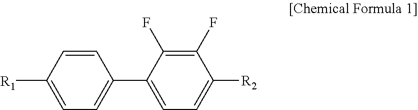
wherein, in Chemical Formula 1 R₁ is an alkyl group having a carbon number of 1 to 10 or a cycloalkyl group having a total carbon number of 3 to 16, and R₂ is an alkoxy group having a carbon number of 1 to 10, and
wherein, the liquid crystal composition does not include a compound having an alkenyl as a substituent group, and
the liquid crystal composition does not include a compound represented by Chemical Formula 4: 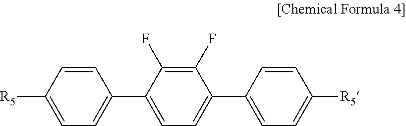
wherein, in Chemical Formula 4, R₅ and R₅′ are independently an alkyl group having a carbon number of 1 to 10 or an alkoxy group having a carbon number of 1 to 10.

7. The liquid crystal display of claim 6, further comprising:
an alignment layer positioned on the field generating electrode;
wherein the alignment layer includes an alignment aid represented by Chemical Formula 5: 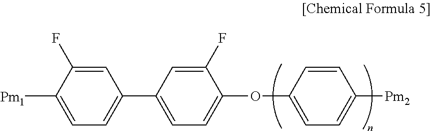
wherein, in Chemical Formula 5, Pm₁ and Pm₂ are each a (meth)acrylate group, and n is 1 to 2.

8. The liquid crystal display of claim 7, wherein
the liquid crystal composition further comprises a second compound represented by Chemical Formula 2: 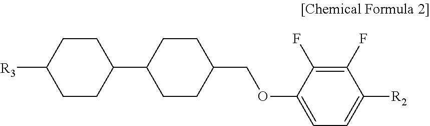
wherein, in Chemical Formula 2, R₂ is an alkoxy group having a carbon number of 1 to 10, and R₃ is an alkyl group having a carbon number of 1 to 8.

9. The liquid crystal display of claim 8, wherein
the first compound is present in an amount of about 20 wt % to about 40 wt % of a total weight of the liquid crystal composition.

10. The liquid crystal display of claim 8, wherein
the first compound is a compound represented by Chemical Formula 1.1: 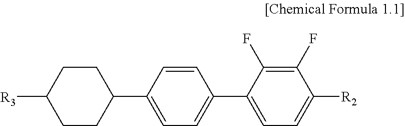
wherein, in Chemical Formula 1.1, R₂ is an alkoxy group having a carbon number of 1 to 10, and R₃ is an alkyl group having a carbon number of 1 to 8.

11. The liquid crystal display of claim 9, wherein
the liquid crystal composition further comprises a compound represented by Chemical Formula 6 to Chemical Formula 8: 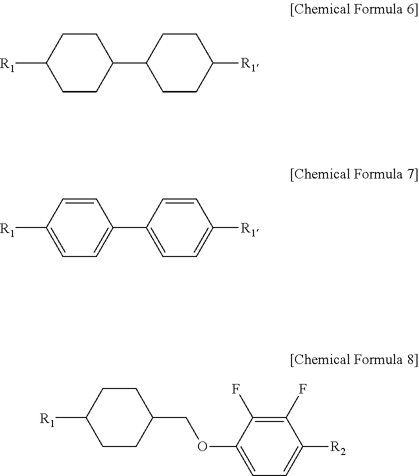
wherein, in Chemical Formula 6 to Chemical Formula 8, R₁ and R₁′ are independently an alkyl group having a carbon number of 1 to 10 or a cycloalkyl group having a total carbon number of 3 to 16, and R₂ is an alkoxy group having a carbon number of 1 to 10.

12. The liquid crystal display of claim 7, wherein
the liquid crystal composition includes a plurality of liquid crystal molecules, and
the liquid crystal molecules are pretilted with respect to the first substrate or the second substrate.

13. The liquid crystal display of claim 12, wherein
the pretilt of the liquid crystal molecules is about 86 degrees to about 87.5 degrees.
